(19) United States
(12) Patent Application Publication
(10) Pub. No.: US 2018/0262302 A1
(43) Pub. Date: Sep. 13, 2018

(54) WIRELESS DEVICE, A NETWORK NODE AND METHODS THEREIN FOR HARQ FEEDBACK PRIORITIZATION

(71) Applicant: Telefonaktiebolaget LM Ericsson (publ), Stockholm (SE)

(72) Inventors: Andreas BERGSTRÖM, Linköping (SE); Jonas FRÖBERG OLSSON, Ljungsbro (SE)

(21) Appl. No.: 15/755,569

(22) PCT Filed: Sep. 3, 2015
(86) PCT No.: PCT/SE2015/050934

§ 371 Date: Feb. 27, 2018

(51) Int. Cl. H04L 1/18; H04W 72/10; H04W 72/04; H04L 12/24

(52) U.S. Cl. CPC H04L 1/1812; H04L 1/1896; H04L 41/0803; H04W 72/042; H04W 72/10

(57) ABSTRACT

A wireless device and a method therein for transmitting one or more Hybrid Automatic Repeat request (HARQ) feedbacks to a network node. The wireless device has a set of HARQ feedback available for transmission. Further, the wireless device and the network node are operating in a wireless communications system. The wireless device obtains a HARQ feedback prioritization indication indicating a priority order of HARQ feedback. Further, the wireless device transmit, to the network node, one or more HARQ feedback in accordance with the indicated priority order, wherein the one or more HARQ feedback are comprised in a proper subset of the set of HARQ feedback.

### TECHNICAL FIELD

Embodiments herein relate to a wireless device, a network node and methods therein. Especially, embodiments herein relate to transmission of one or more Hybrid Automatic Repeat reQuest (HARQ) feedback.

### BACKGROUND

Communication devices such as terminals or wireless devices are also known as e.g. User Equipments (UE), mobile terminals, wireless terminals and/or mobile stations. Such terminals are enabled to communicate wirelessly in a wireless communication system or a cellular communications network, sometimes also referred to as a cellular radio system or cellular networks. The communication may be performed e.g. between two terminals, between a terminal and a regular telephone and/or between a terminal and a server via a Radio Access Network (RAN) and possibly one or more core networks, comprised within the cellular communications network.

The above terminals or wireless devices may further be referred to as mobile telephones, cellular telephones, laptops, or tablets with wireless capability, just to mention some further examples. The terminals or wireless devices in the present context may be, for example, portable, pocket-storable, hand-held, computer-comprised, or vehicle-mounted mobile devices, enabled to communicate voice and/or data, via the RAN, with another entity, such as another terminal or a server.

The cellular communications network covers a geographical area which is divided into cell areas, wherein each cell area being served by an access node such as a base station, e.g. a Radio Base Station (RBS), which sometimes may be referred to as e.g. “eNB”, “eNodeB”, “NodeB”, “B node”, or BTS (Base Transceiver Station), depending on the technology and terminology used. The base stations may be of different classes such as e.g. macro eNodeB, home eNodeB or pico base station, based on transmission power and thereby also cell size. A cell is the geographical area where radio coverage is provided by the base station at a base station site. One base station, situated at the base station site, may serve one or several cells. Further, each base station may support one or several communication technologies. The base stations communicate over the air interface operating on radio frequencies with the terminals or wireless devices within range of the base stations. In the context of this disclosure, the expression Downlink (DL) is used for the transmission path from the base station to the mobile station. The expression Uplink (UL) is used for the transmission path in the opposite direction i.e. from the mobile station to the base station.

In 3rd Generation Partnership Project (3GPP) Long Term Evolution (LTE), base stations, which may be referred to as eNodeBs or even eNBs, may be directly connected to one or more core networks.

3GPP LTE radio access standard has been written in order to support high bitrates and low latency both for uplink and downlink traffic. All data transmission is in LTE controlled by the radio base station.

A Hybrid Automatic Repeat reQuest (hybrid ARQ or HARQ) operation is implemented to correct error packets in the PHYsical (PHY) layer and is controlled by the Medium Access Control (MAC) layer. The HARQ is a combination of high-rate forward error-correcting coding and ARQ error-control.

In standard ARQ, redundant bits are added to a data message that is to be transmitted from a sender to a receiver using an Error-Detecting (ED) code such as a Cyclic Redundancy Check (CRC). When the receiver detects a corrupted message it will send an indication, e.g. a HARQ feedback, to the sender. The indication indicates whether or not the message was correctly received.

In HARQ, the message is attached with an ED code, e.g. a CRC. Then the message and the CRC is encoded using a Forward Error Correction (FEC) code. Thereafter, the encoded message is transmitted to the receiver that attempts to decode the message. If the receiver succeeds to decode the message and if the CRC check also succeeds, then the receiver decides that the message was correctly received, otherwise the message was not correctly received. When the receiver detects an erroneous data message it buffers the data and sends an indication, e.g. a HARQ feedback, to the sender. Further, when the receiver receives the re-transmitted data, the receiver may then combine the re-transmitted data with the buffered data prior to channel decoding and error detection.

Transmission of HARQ feedback from the receiver, e.g. the UE, to the sender, e.g. the base station, is necessary for the HARQ operation. The HARQ feedback is an ACK if the message was correctly received at the receiver, e.g. the UE, and a NACK if the message was not correctly received.

Today, in LTE, there are a fixed number of so-called stop-and-wait HARQ processes where each HARQ process may buffer one transmission. This means that if a first HARQ process has been used for a first transmission, the first HARQ process will buffer the first transmission, and thus a re-transmission of the first transmission may be done. Further, before the sender transmits a second transmission using the first HARQ process it need to stop-and-wait for an ACK of the first transmission. In LTE downlink, an asynchronous HARQ operation is used wherein there is no time-dependency when a HARQ process may be used. Using the example above, the first HARQ process may be used for the second transmission even if the ACK has not be received for the first transmission on the HARQ process. To the contrary, in LTE uplink, there is a strict time-dependency when a HARQ process is allowed to be used. In the asynchronous HARQ operation, one or more HARQ feedback reports are sent from the receiver, e.g. a UE, of a message sent from the sender, e.g. a network (NW), in a rather autonomous manner. By the expression “HARQ feedback report” when used in this disclosure is meant a message comprising one or more HARQ feedback, e.g. one or more indications. The HARQ feedback report in its simplest form is just one bit indicating an ACK or a NACK of a HARQ process. A more complex HARQ feedback report comprises several ACK and/or NACK bits and several HARQ process indication bits explicitly indicating which HARQ process the respective ACK/NACK bit refers to. Hence, a HARQ feedback report is a message indicating one or more HARQ feedback and their associated HARQ processes, wherein the associated HARQ processes may either be implicitly or explicitly indicated in the message. The HARQ feedback reports may be transmitted either on a Physical Uplink Control CHannel (PUCCH) or a Physical Uplink Shared CHannel (PUSCH) depending on whether the UE has been scheduled for uplink PUSCH transmission or not. In this disclosure, the terms “HARQ feedback report” and “HARQ feedback” will be used interchangeable.

In upcoming enhancements of LTE, wherein the assumed mode of operation is Time-Division Duplex (TDD), e.g. dynamic TDD, the number of HARQ processes is expected to increase quite significantly because of the greatly increased data rates and shortened Transmission-Time Interval (TTI). Given a scenario with a lot of DL transmissions for such an enhanced LTE system, the TDD configuration will be such that many subframes are configured for DL usage whereas relatively few will be configured for UL usage. Hence, the HARQ feedback may be provided in the UL rather seldom. In addition, due to the very large number of active HARQ processes, e.g. HARQ receiver (Rx) processes, in the UE, for which HARQ feedback is required by the NW, these reports will be rather large and resource demanding.

### SUMMARY

Therefore, an object of embodiments herein is to overcome the above-mentioned drawbacks among others and to improve the performance in a wireless communications system.

According to a first aspect of embodiments herein, the object is achieved by a method performed by a wireless device for transmitting one or more Hybrid Automatic Repeat reQuest (HARQ) feedback to a network node. The wireless device has a set of HARQ feedback available for transmission. Further, the wireless device and the network node are operating in a wireless communications system.

The wireless device obtains a HARQ feedback prioritization indication indicating a priority order of HARQ feedback.

Further, the wireless device transmits, to the network node, one or more HARQ feedback in accordance with the indicated priority order, wherein the one or more HARQ feedback are comprised in a proper subset of the set of HARQ feedback.

According to a second aspect of embodiments herein, the object is achieved by a wireless device for transmitting one or more Hybrid Automatic Repeat reQuest (HARQ) feedback to a network node. The wireless device has a set of HARQ feedback available for transmission. Further, the wireless device and the network node are operating in a wireless communications system.

The wireless device is configured to obtain a HARQ feedback prioritization indication indicating a priority order of HARQ feedback.

Further, the wireless device is configured to transmit, to the network node, one or more HARQ feedback in accordance with the indicated priority order, wherein the one or more HARQ feedback are comprised in a proper subset of the set of HARQ feedback.

According to a third aspect of embodiments herein, the object is achieved by a method performed by a network node for receiving one or more Hybrid Automatic Repeat reQuest (HARQ) feedback from a wireless device having a set of HARQ feedback available for transmission. The network node and the wireless device are operating in a wireless communications system.

The network node obtains a HARQ feedback prioritization indication indicating a priority order of HARQ feedback.

Further, the network node configures the wireless device to transmit one or more HARQ feedback in accordance with the indicated priority order.

Furthermore, the network node receives, from the wireless device, one or more HARQ feedback transmitted in accordance with the indicated priority order, wherein the one or more HARQ feedback are comprised in a proper subset of the set of HARQ feedback.

According to a fourth aspect of embodiments herein, the object is achieved by a network node for receiving one or more Hybrid Automatic Repeat reQuest (HARQ) feedback from a wireless device having a set of HARQ feedback available for transmission. The network node and the wireless device are operating in a wireless communications system.

The network node is configured to obtain a HARQ feedback prioritization indication indicating a priority order of HARQ feedback.

Further, the network node is configured to configure the wireless device to transmit one or more HARQ feedback in accordance with the indicated priority order.

Furthermore, the network node is configured to receive, from the wireless device, one or more HARQ feedback transmitted in accordance with the indicated priority order, wherein the one or more HARQ feedback are comprised in a proper subset of the set of HARQ feedback.

According to a fifth aspect of embodiments herein, the object is achieved by a computer program, comprising instructions which, when executed on at least one processor, causes the at least one processor to carry out the method performed by the wireless device.

According to a sixth aspect of embodiments herein, the object is achieved by a computer program, comprising instructions which, when executed on at least one processor, causes the at least one processor to carry out the method performed by the network node.

According to a seventh aspect of embodiments herein, the object is achieved by a carrier comprising the computer program, wherein the carrier is one of an electronic signal, an optical signal, a radio signal or a computer readable storage medium.

Since the wireless device having a set of HARQ feedback available for transmission, obtains a HARQ feedback prioritization indication indicating a priority order of HARQ feedback, and transmits, to the network node, one or more HARQ feedback in accordance with the indicated priority order, wherein the one or more HARQ feedback are comprised in a proper subset of the set of HARQ feedback, the wireless device is transmitting a reduced number of HARQ feedback in a prioritized way. Thereby, the amount of resources used for HARQ feedback transmission is reduced and the resources not used for HARQ feedback transmission may instead be used for other transmissions such as delay critical transmission, e.g. Critical Machine Type Communication (C-MTC). This results in an improved performance in the wireless communications system.

An advantage with embodiments herein is an improved usage of resources.

Another advantage is that it is ensured that delay critical transmission are prioritized. This may especially be the case when the delay critical transmissions are multiplexed with delay insensitive data such as a background service, e.g. a file download, application software update and/or a best-effort service, e.g. web browsing.

### BRIEF DESCRIPTION OF DRAWINGS

Examples of embodiments herein will be described in more detail with reference to attached drawings in which:

FIG. 1 schematically illustrates an embodiment of a wireless communications system;

FIG. 2 is a schematic combined flowchart and signalling scheme of embodiments of a wireless communications system;

FIG. 3 is a flowchart depicting embodiments of a method performed by a wireless device;

FIG. 4 is a schematic block diagram illustrating embodiments of a wireless device;

FIG. 5 is a flowchart depicting embodiments of a method performed by a network node; and

FIG. 6 is a schematic block diagram illustrating embodiments of a network node.

### DETAILED DESCRIPTION

As part of developing embodiments herein, some problems with the state of the art wireless communications systems will first be identified and discussed.

Today, there may be situations when it is not possible for a receiver, e.g. a UE, to provide HARQ feedback to a sender, e.g. a network, for all ongoing DL HARQ processes. This is something which may happen in a number of situations. By the expression “HARQ feedback” when used in this disclosure is meant an indication of a correct or an incorrect reception of a HARQ process, e.g. a transmission. The indication may comprise one bit such as an ACK or a NACK. Further, by the expression “ongoing HARQ processes” when used in this disclosure is meant a HARQ process with an associated transmission from the sender to the receiver. The ongoing HARQ process may sometimes herein be referred to as an active HARQ process associated with an ongoing transmission or associated with a transmission that has occurred or has been performed.

For example, in some situations it may be desired that the receiver, e.g. a wireless device, only sends some of the HARQ feedback. Assume that the receiver receives an UL grant from the sender, e.g. a network node. The UL grant comprises information relating to one or more resources to be used for HARQ feedback and user data. Suppose now that the receiver receives a mission-critical data message from a higher layer, e.g. from a MAC layer, and that the amount of mission-critical data and HARQ feedback exceeds the amount of resources granted in the UL grant. In the current state-of-the-art solution, the receiver will send all the HARQ feedback and only a part of the mission-critical data on the granted resources. The rest of the mission-critical data will be transmitted when the granted resources are available for transmission again. This means that the delivery of the mission-critical data to its receiver will be delayed. By the expression “mission-critical data and/or mission-critical data message” when used herein is meant data and/or data message that is important for the receiver to receive with a very short latency, e.g. short delay, and/or with a high reliability. The data and/or data message may be or relate to for example Critical Machine Type Communications (C-MTC), e.g. to communications comprising or relating to one or more of tactile applications such as remote surgery, remote vehicle and/or robotic control, emergency alarms etc., and/or gaming applications with strict delay requirements and/or multimedia services such as Voice over IP (VoIP), Voice over LTE (VoLTE), Video over IP (ViIP) and Video over LTE (ViLTE). Further, the mission-critical data may be sent from a first transmitter over several intermediate receivers and transmitters before reaching a final receiver.

Also, in some scenarios the network, e.g. the network node, may not have full knowledge about the exact number of bits that are to be comprised in the HARQ feedback the receiver, e.g. the wireless device, will transfer. For example, this may be the case in a dual-connectivity scenario, wherein the considered receiver has UL connections towards more than one network node, e.g. more than one uncoordinated or loosely coordinated network node. Then, the wireless device may receive an UL grant from each of the network nodes and thus the wireless device may receive two or more contradictory UL grants for sending HARQ feedback. Assuming that the wireless device is allowed to resolve the contradiction by e.g. removing the overlapping resource blocks from one of the assignments. However, then the wireless device may not be able to transmit all HARQ feedback.

In some of the above scenarios, one may consider reconfiguration of the size of the HARQ feedback channel, e.g. the size of the PUCCH or the PUSCH, in order to cope with the temporary variations. However, since these variations are indeed temporary, this is deemed to be a too costly approach and many cases lead to overprovisioning of these resources. Hence a better mechanism is desired.

As described above, it may not be possible for the wireless device to feed back the status of all ongoing DL HARQ processes to the network node. Hence, the wireless device may need to make a prioritization of which one or more of the HARQ processes that are more important than the others to report. However, today such a mechanism is not available.

Therefore, in some embodiments described herein, the wireless device is provided with information relating to a priority order, e.g. a relative priority order, of the HARQ feedback for the HARQ processes. In some embodiments, there is one HARQ feedback for each HARQ process. For example, the wireless device is provided with information relating to which HARQ process that is more important to transmit an HARQ feedback for and which is less important in case of for example a truncation and/or a limitation on the number of HARQ feedback that is be transmitted. In this manner, any potential retransmission for a more delay critical service, such as Critical Machine Type Communications (C-MTC), and/or other services such as delay sensitive gaming, VoIP, VoLTE, ViIP, ViLTE, is performed with the shortest delay possible. Another possibility is to prioritize HARQ feedback relating to NACKs over HARQ feedback relating to ACKs. In other words, the status reporting for HARQ processes requiring retransmissions are prioritized higher than HARQ processes having successful transmissions.

Further, in some embodiments, the wireless device is provided with a set of rules defining a relative priority order of the HARQ feedback reporting per HARQ process. In other words, the set of rules may define a higher priority to a first HARQ process that is more important to report, e.g. to transmit an HARQ feedback for, and a lower priority to a second HARQ process that is less important to report. This may be advantageous, in case a truncation and/or limitation of the number of reported HARQ process is required, i.e. in case the number of HARQ feedback need to be limited and/or truncated.

Terminology

The following terminology is used in embodiments described herein and is elaborated below:

Network node: In some embodiments a more general term “network node” is used and it may correspond to any type of radio network node or any network node, which communicates with a UE and/or with another network node. Examples of network nodes are NodeB, MeNB, SeNB, a network node belonging to a Master Cell Group (MCG) or a Secondary Cell Group (SCG), Base Station (BS), multi-Standard Radio (MSR) radio node such as MSR BS, eNodeB, network controller, radio Network Controller (RNC), Base Station Controller (BSC), relay, donor node controlling relay, Base Transceiver Station (BTS), Access Point (AP), transmission points, transmission nodes, Radio Remote Unit (RRU), Remote Radio Head (RRH), nodes in Distributed Antenna System (DAS), core network node (e.g. Mobile Switching Center (MSC), Mobility Management Entity (MME) etc), Operations and Maintenance (O&M), Operations Support System (OSS), Self-organizing Network (SON), positioning node (e.g. Enhanced Serving Mobile Location Center (E-SMLC)), Mobile Data Terminal (MDT) etc.

User equipment/wireless device: In some embodiments the non-limiting terms wireless device and User Equipment (UE) are used and they refer to any type of wireless device communicating with a network node and/or with another UE in a cellular or mobile communication system. Examples of UE/wireless device are Device-to-Device (D2D) UE, machine type UE or UE capable of machine to machine (M2M) communication, Personal Digital Assistant (PDA), Tablet, mobile terminals, smart phone, Laptop Embedded Equipped (LEE), Laptop Mounted Equipment (LME), Universal Serial Bus (USB) dongles etc. In this disclosure the terms wireless device and UE are used interchangeably.

General

Note that although terminology from 3GPP LTE has been used in this disclosure to exemplify embodiments, this should not be seen as limiting the scope of the invention to only the aforementioned system. Other wireless systems, including Wideband Code Division Multiple Access (WCDMA), High Speed Packet Access (HSPA), Worldwide Interoperability for Microwave Access (WiMax), WiFi, Wireless Local Area Network (WLAN), and Global System for Mobile Communications (GSM)/GSM EDGE Radio Access Network (GERAN), may also benefit from exploiting the ideas covered within this disclosure.

Also note that terminology such as eNodeB and UE should be considering non-limiting and does in particular not imply a certain hierarchical relation between the two; in general “eNodeB” could be considered as device 1 and “UE” device 2, and these two devices communicate with each other over some radio channel.

Further, the description frequently refers to wireless transmissions in the downlink, but embodiments herein are equally applicable in the uplink. Thus, even if some embodiments in this disclosure are applied to downlink transmission of data and hence uplink transmission of HARQ feedback, the same procedures may be applied also for uplink transmission of data and downlink transmission of HARQ feedback.

Furthermore, the embodiments are described in the context of single carrier operation of the UE. However, the embodiments are applicable for multi-carrier or carrier aggregation operation of the UE. Therefore, the embodiment methods of signaling information to the UE or to the other network node may be carried out independently for each cell on each carrier frequency supported by the network node.

In the following section, embodiments herein will be illustrated in more detail by a number of exemplary embodiments. It should be noted that these embodiments are not mutually exclusive. Components from one embodiment may be assumed to be present in another embodiment and it will be obvious to a person skilled in the art how those components may be used in the other exemplary embodiments.

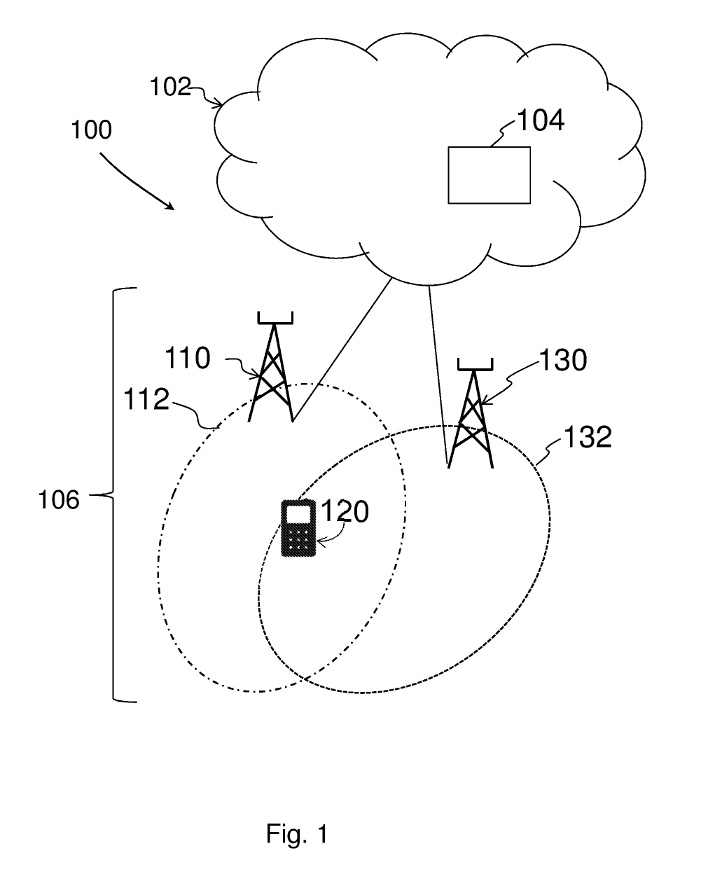

FIG. 1 depicts an example of a wireless communications system 100 in which embodiments herein may be implemented. The wireless communications system 100 is a wireless communication system such as an LTE system, a WCDMA system, a GSM system, any 3GPP cellular system, WiMAX system, or any wireless network/system.

A core network 102 is comprised in the wireless communications system 100. The core network 102 is a wireless core network such as an LTE core network, e.g. a Evolved Packet Core (EPC); a WCDMA core network; a GSM core network; any 3GPP core network; WiMAX core network; or any cellular core network.

A core network node 104 is comprised in the core network 102. The core network node 104 may be a Mobile Switching Center (MSC), a Mobility Management Entity (MME), an Operation & Maintenance (O&M) node, a Serving GateWay (S-GW), a Serving General Packet Radio Service (GPRS) Node (SGSN), etc.

A wireless communications network 106 is comprised in the wireless communications system 100. The wireless communications network 106 is a wireless communications network such as an LTE communications network, e.g. an Evolved UMTS Terrestrial Radio Access network (E-UTRAN); a WCDMA communications network; a GSM communications network; any 3GPP communications network; WiMAX communications network; or any cellular communications network.

It should be understood that in some embodiments the core network 102 and the wireless communications network 106 are combined into one single network or that the wireless communications network 106 may comprise the core network 102.

A network node 110, sometimes herein referred to as a first network node, is comprised in the wireless communications system 100. The network node 110 is configured to operate in the wireless communications system 100. A second network node 130 may be comprised in the wireless communications system 100. The network node 110 and the second network node 130 may each be a radio access node such as a radio base station, for example an eNB, an eNodeB, or a Home Node B, an Home eNode B or any other network node capable to serve a user equipment or a machine type communication device in a wireless communications network.

The network node 110 may be a Radio Network Node (RNN) and is configured for wireless communication with one or more wireless devices, such as a wireless device 120, when located within a geographical area 112, served by the network node 110. Herein, this is also specified as the network node 110 manages or is configured to manage communication with one or more wireless devices in the geographical area 112. In this disclosure, the geographical area 112 is sometimes referred to as a first geographical area, coverage area or cell.

The second network node 130 is configured for wireless communication with one or more wireless devices, such as the wireless device 120, when located within a geographical area 132 served by the second network node 130. Herein, this is also specified as the second network node 130 manages or is configured to manage communication with one or more wireless devices in the geographical area 132. In this disclosure the In this disclosure, the geographical area 132 is sometimes referred to as a second geographical area, coverage area or cell.

The wireless device 120 also referred to as a user equipment or UE is located in the wireless communications system 100. The first wireless device 120 may e.g. be a user equipment, a mobile terminal or a wireless terminal, a mobile phone, a computer such as e.g. a laptop, a Personal Digital Assistants (PDAs) or a tablet computer, sometimes referred to as a surf plate, with wireless capability, or any other radio network units capable to communicate over a radio link in a wireless communications network. It should be noted that the term user equipment used in this document also covers other wireless devices such as Machine to Machine (M2M) devices, even though they are not handled by any user.

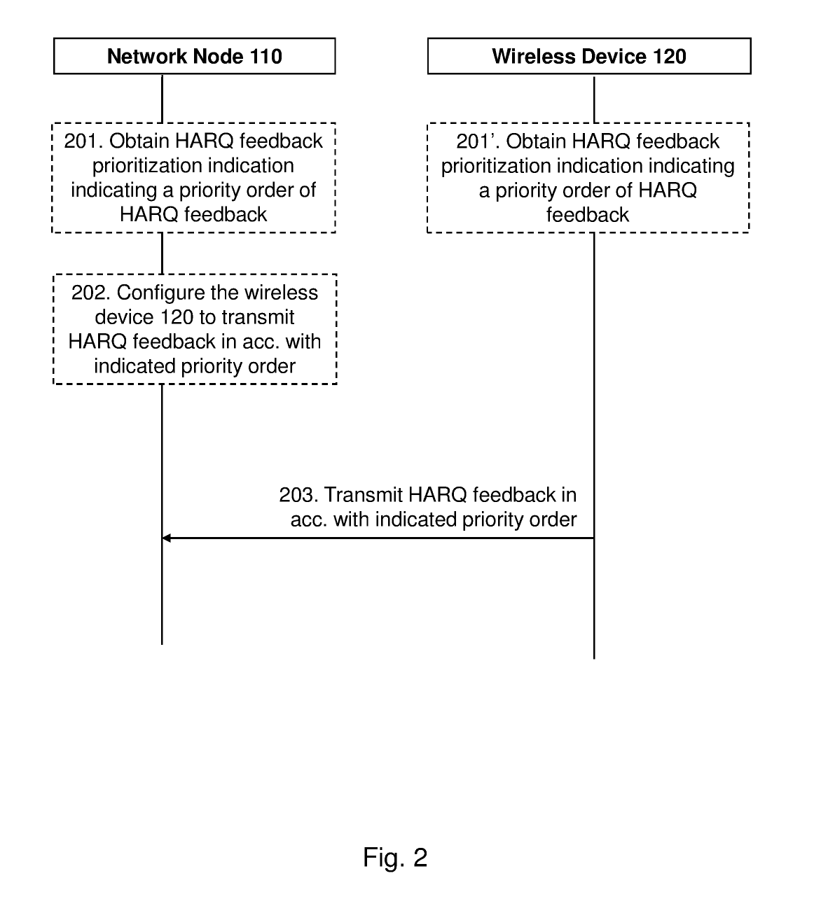

An example of a method performed in embodiments of the wireless communications system 100 for transmitting one or more HARQ feedback to the network node 110 will now be described with reference to a schematic combined flowchart and signalling scheme illustrated in FIG. 2. As mentioned above, the wireless device 120 has a set of HARQ feedback available for transmission. For example, the wireless device 120 may have obtained the set of HARQ feedback or transmission from an attempt to decode one or more received transmissions. Further, the wireless device 120 and the network node 110 are operating in the wireless communications network 100.

The method comprises one or more of the following actions. It should be understood that some actions are optional, that some actions may be taken in another suitable order and that actions may be combined.

Action 201

The network node 110 may obtain an indication of HARQ feedback prioritization which indication indicates a priority order of HARQ feedback. In this disclosure, the indication is sometimes referred to as a HARQ feedback prioritization indication.

As will be described below in Action 501, the network node 110 may obtain the HARQ feedback prioritization indication indicating the priority order by receiving the HARQ feedback prioritization indication from another network node, such as the network node 130, e.g. a radio network node, or the core network node 104, comprised in the wireless communications system 100.

This Action relates to Action 501 that will be described in more detail below.

Action 201′

In some embodiments, the wireless device 120 obtains the HARQ feedback prioritization indication, which indication indicates the priority order of HARQ feedback.

As will be described below in relation to Action 502, the wireless device 120 may receive the HARQ feedback prioritization indication from the network node 110 when for example the network node 110 configures the wireless device 120. However, the wireless device 120 may also determine the HARQ feedback prioritization indication, cf. Action 301.

This Action relates to Actions 301 and 502 that will be described in more detail below.

Action 202

In some embodiments wherein the network node 110 has obtained the indication, the network node 110 configures the wireless device 120 to transmit HARQ feedback in accordance with the indicated priority. Thus, in such embodiments, the wireless device 120 receives the HARQ feedback prioritization indication from the network node 110.

This Action relates to Action 502 that will be described in more detail below.

Action 203

The wireless device 120 transmits, to the network node 110, the HARQ feedback in accordance with the indicated priority order. As mentioned above, the priority order is given by the indication obtained by the network node 110 and/or the wireless device 120.

By transmitting the HARQ feedback in accordance with the priority order, only prioritized HARQ feedback are transmitted. Thereby, the amount of resources used for HARQ feedback transmission is reduced and the resources not used for HARQ feedback transmission may instead be used for other transmissions such as delay critical transmission, e.g. Critical Machine Type Communication (C-MTC). This results in an improved performance in the wireless communications system.

This Action relates to Actions 302 and 503 that will be described in more detail below.

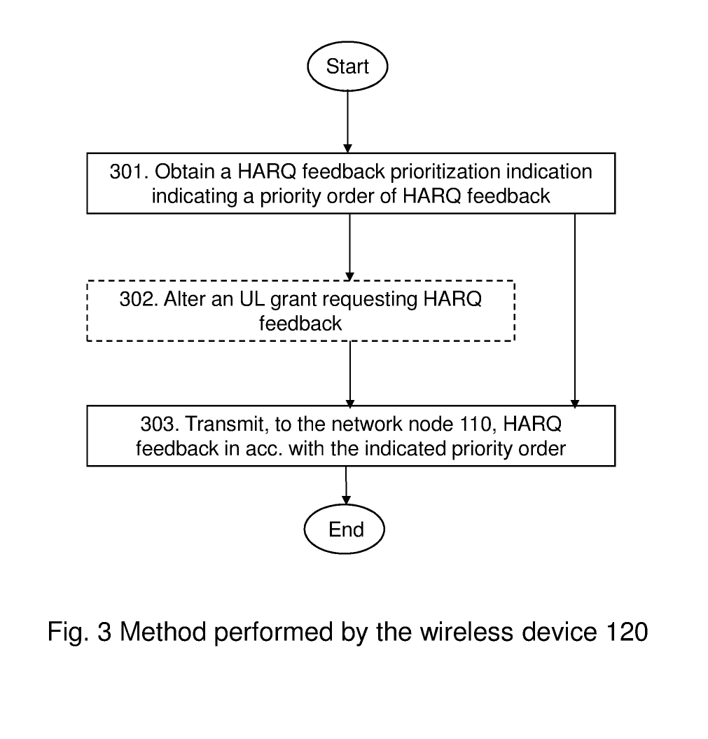

An example of a method performed by the wireless device 120 for transmitting one or more HARQ feedback to the network node 110 will now be described with reference to a flowchart depicted in FIG. 3. As mentioned above, the wireless device 120 has the set of HARQ feedback available for transmission. Further, the wireless device 120 and the network node 110 are operating in the wireless communications network 100.

The methods comprise one or more of the following actions. It should be understood that these actions may be taken in any suitable order and that some actions may be combined.

Action 301

The wireless device 120 obtains a HARQ feedback prioritization indication indicating a priority order of HARQ feedback. This may also be referred to as the wireless device 120 obtains an indication of a priority order related to HARQ feedback. In this disclosure, and as previously mentioned, the HARQ feedback prioritization indication is sometimes referred to as just the indication.

It should be understood that the expression “the wireless device 120 obtains a HARQ feedback prioritization indication indicating a priority order of HARQ feedback” when used in this disclosure is used as a generic expression. For example, and as will be described below, the expression encompasses that the wireless device 120 receives the indication of the priority order from another node or determines the priority order itself. Further, it should also be understood that a determined priority order may be considered as an indication of a priority order.

In some embodiments, the wireless device 120 receives the HARQ feedback prioritization indication from the network node 110.

As previously mentioned, the network node 110 may configure the wireless device 120 to transmit the HARQ feedback in accordance with the indicated priority. In such cases, the wireless device 120 may receive the indication when being configured by the network node 110. As will be described below, the network node 110 may configure the wireless device 120 via higher layer signalling such as Radio Resource Control (RRC) signalling or via lower layer signalling such as MAC/PHY layer signalling.

In addition or alternatively, the wireless device 120 may obtain the HARQ feedback prioritization indication indicating the priority order by determining the priority order of HARQ feedback based on a pre-defined set of HARQ feedback priorities. For example, the pre-defined set of HARQ feedback priorities may be given by the standard specification, e.g. by the 3GPP MAC protocol standard. An activation of priority may be controlled using an RRC message There may also be several pre-defined sets of HARQ feedback priorities specified by the MAC protocol standard, wherein a RRC message may indicate an activation and which of the pre-defined sets of HARQ feedback priorities to be used.

Further, the wireless device 120 may obtain the HARQ feedback prioritization indication indicating the priority order by determining the priority order based on one or more of a HARQ process associated with the HARQ feedback, a Downlink Control Information (DCI) and/or a redundancy version.

For example, the priority order based on one or more of the HARQ process associated with the HARQ feedback may be determined by determining that a HARQ process having a lower number has a higher priority than a HARQ process having a higher number. For example, when a DL transmission occurs it is indicated to the wireless device 120 which HARQ process out of a number of HARQ process should be used for the transmission. This may indicated in the DCI using one or more bits, e.g. 3 bits. This imply indexation of the HARQ processes, i.e., numbering of the HARQ processes.

Further, a HARQ feedback for a HARQ process indicated by 000 may have a higher priority than a HARQ feedback for a HARQ process indicated by 001, and a HARQ process indicated by 001 may have a higher priority than a HARQ feedback for a HARQ process indicated by 010, and so on.

As another example, the priority order based on the DCI may be determined by determining that a HARQ feedback for a transmission granted using DCI Format X has a higher priority than a HARQ feedback for a transmission granted using DCI Format Y. For example, the DCI Formats X and Y may be any one of the present different formats e.g. 2, 2D or any future suitable format.

As yet another example, the priority order based on the redundancy version may be determined by determining that a HARQ feedback for a transmission using a higher redundancy version has a higher priority than a HARQ feedback for a transmission using a lower redundancy version.

As a further example, the priority order may be determined by determining that a HARQ feedback for a second re-transmission attempt has a higher priority than a HARQ feedback for a new transmission or a first re-transmission.

In some embodiments, the wireless device 120 receives the HARQ feedback prioritization indication indicating the priority order in a grant, e.g. a scheduling grant, transmitted from a network node, such as the network node 110. The grant may comprise or realise the HARQ feedback prioritization indication. Further, the grant may indicate a HARQ priority for a certain transmission.

As will be described in more detail below with reference to e.g. Action 502, the network node 110 may configure the wireless device 120 to transmit HARQ feedback in accordance with the indicated priority order. As will be described, the network node 110 may then configure the wireless device 120 with a HARQ feedback prioritization table, wherein the table indicates one or more HARQ feedback priorities and what values should match e.g., redundancy version, DCI format, HARQ process, modulation, etc. For example, the table may have an entry specifying that a HARQ feedback for a transmission granted using DCI Format X and that the transmission is using HARQ process 3, 16QAM modulation, redundancy version 2 has priority P. In another example, the table may have an entry specifying that a HARQ feedback for a transmission granted DCI Format X and that the transmissions is using HARQ process 3 has priority P, regardless of the used modulation, redundancy version etc. In such cases, when the wireless device 120 receives a grant, i.e., DCI, it searches through the HARQ feedback prioritization table and finds a table entry that matches the information in the received grant. The found table entry then determines the HARQ feedback priority to be used by the wireless device 120 when transmitting the one or more HARQ feedback to the network node 110.

This Action relates to Actions 201, 201′, 202 described above.

Action 302

As mentioned above, in some scenarios, the network node 110 may not have full knowledge about the number of bits comprised in the HARQ feedback the wireless device 120 will transfer. For example, this may be the case in a dual-connectivity scenario, wherein the wireless device 120 has several uplink connections towards more than one network node. With reference to FIG. 1, in a dual-connectivity scenario, the wireless device 120 may have uplink connections to the network nodes 110, 130. These network nodes 110 and 130 may then be referred to as a first network node and a second network node, respectively. In order to handle dual-connectivity and in some embodiments, the wireless device 120 is allowed to alter an UL grant, e.g. a received or provided UL grant, requesting HARQ feedback. By altering the UL grant, e.g. by altering the amount of resources used for transmission of HARQ feedback, one or more HARQ feedback will be transmitted on the available amount of resources in accordance with the indicated priority order. Thereby, the wireless device 120 may transmit, on the available resources for transmission, HARQ feedback for latency and/or mission critical MTC data having a higher priority than HARQ feedback, e.g. ACKs, for less prioritized services.

Action 303

The wireless device 120 transmits to the network node 110, one or more HARQ feedback in accordance with the indicated priority order, wherein the one or more HARQ feedback are comprised in a proper subset of the set of HARQ feedback.

It should be understood that the expression “proper subset” when used in this disclosure refers to a strict subset i.e. a subset that does not include all elements of the set. Thus, the number of elements comprised in the proper subset is less than the number of elements comprised in the set. Further, it should be understood that the proper subset may comprise zero elements.

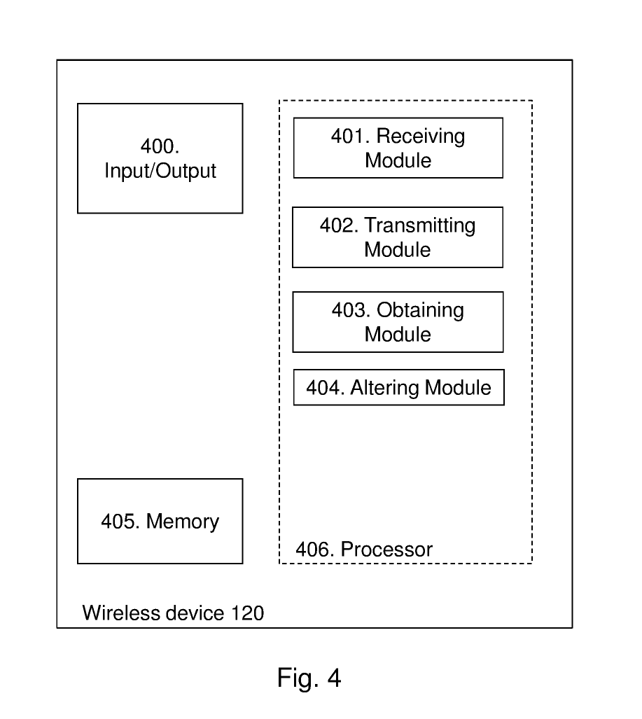

To perform the method for transmitting one or more HARQ feedback to the network node 110, the wireless device 120 may be configured according to an arrangement depicted in FIG. 4. As previously described, the wireless device 120 has the set of HARQ feedback for transmission. Further, the wireless device 120 and the network node 110 are operating in the wireless communications system 100.

In some embodiments, the wireless device 120 comprises an input and/or output interface 400 configured to communicate with one or more wireless devices, one or more radio nodes, e.g. the network nodes 120, 130, and one or more other network nodes, such as the core network node 104. The input and/or output interface 400 may comprise a wireless receiver (not shown) and a wireless transmitter (not shown).

The wireless device 120 is configured to receive, by means of a receiving module 401 configured to receive, transmissions from the network node 110. The receiving module 401 may be implemented by or arranged in communication with a processor 406 of the wireless device 120. The processor 406 will be described in more detail below.

In some embodiments, the wireless device 120 is configured to receive an HARQ feedback prioritization indication from the network node 110.

The wireless device 120 is configured to transmit, by means of a transmitting module 402 configured to transmit, to the network node 110, one or more HARQ feedback in accordance with the indicated priority order, wherein the one or more HARQ feedback are comprised in a proper subset of the set of HARQ feedback. The transmitting module 402 may be implemented by or arranged in communication with the processor 406 of the wireless device 120.

The wireless device 120 is configured to obtain, by means of an obtaining module 403 configured to obtain, a HARQ feedback prioritization indication indicating a priority order of HARQ feedback. The obtaining module 403 may be implemented by or arranged in communication with the processor 406 of the wireless device 120.

In some embodiments, the wireless device 120 is configured to obtain the HARQ feedback prioritization indication indicating the priority order by further being configured to receive the HARQ feedback prioritization indication from the network node 110.

Alternatively or in addition, the wireless device 120 may be configured to obtain the HARQ feedback prioritization indication indicating the priority order by further being configured to determine the priority order of HARQ feedback based on a pre-defined set of HARQ feedback priorities.

Further, the wireless device 120 may be configured to obtain the HARQ feedback prioritization indication indicating the priority order by further being configured to determine the priority order based on one or more of a HARQ process associated with the HARQ feedback, a Downlink Control Information (DCI) and/or a redundancy version.

In some embodiment, the wireless device 120 is configured to alter, by means of an altering module 404 configured to alter, an UL grant requesting HARQ feedback. The UL grant may be an UL grant received from or provided by the network node 110. The altering module 404 may be implemented by or arranged in communication with the processor 406 of the wireless device 120

As mentioned above, the network node 110 may not have full knowledge about the number of HARQ feedback the wireless device 120 will transfer. For example, this may be the case in a dual-connectivity scenario, wherein the wireless device 120 has UL connections towards more than one network node 110,130, e.g. to more than one uncoordinated and/or loosely coordinated network node. Therefore, in some embodiments, the wireless device 120 is configured to alter the UL grant requesting HARQ feedback. By altering the provided UL grant, the resources available for transmission is altered. Thereby, the wireless device 120 may transmit, on the available resources for transmission, HARQ feedback for latency and/or mission critical data, e.g. MTC data, having a higher priority than HARQ feedback, e.g. ACKs, for less prioritized services. This may be the case despite the resources assigned in the received UL grant.

The wireless device 120 may also comprise means for storing data. In some embodiments, the wireless device 120 comprises a memory 405 configured to store the data. The data may be processed or non-processed data and/or information relating thereto. The memory 405 may comprise one or more memory units. Further, the memory 405 may be a computer data storage or a semiconductor memory such as a computer memory, a read-only memory, a volatile memory or a non-volatile memory. The memory is arranged to be used to store obtained information, data, configurations, schedulings, and applications etc. to perform the methods herein when being executed in the wireless device 120.

Embodiments herein for transmitting one or more HARQ feedback to the network node 110 may be implemented through one or more processors, such as the processor 406 in the arrangement depicted in FIG. 4, together with computer program code for performing the functions and/or method actions of embodiments herein. The program code mentioned above may also be provided as a computer program product, for instance in the form of a data carrier carrying computer program code for performing the embodiments herein when being loaded into the wireless device 120. One such carrier may be in the form of an electronic signal, an optical signal, a radio signal or a computer readable storage medium. The computer readable storage medium may be a CD ROM disc or a memory stick.

The computer program code may furthermore be provided as program code stored on a server and downloaded to the wireless device 120.

Those skilled in the art will also appreciate that the input/output interface 400, the receiving module 401, the transmitting module 402, the obtaining module 403 and the altering module 404 above may refer to a combination of analog and digital circuits, and/or one or more processors configured with software and/or firmware, e.g. stored in the memory 405, that when executed by the one or more processors such as the processors in the wireless device 120 perform as described above. One or more of these processors, as well as the other digital hardware, may be included in a single Application-Specific Integrated Circuitry (ASIC), or several processors and various digital hardware may be distributed among several separate components, whether individually packaged or assembled into a System-on-a-Chip (SoC).

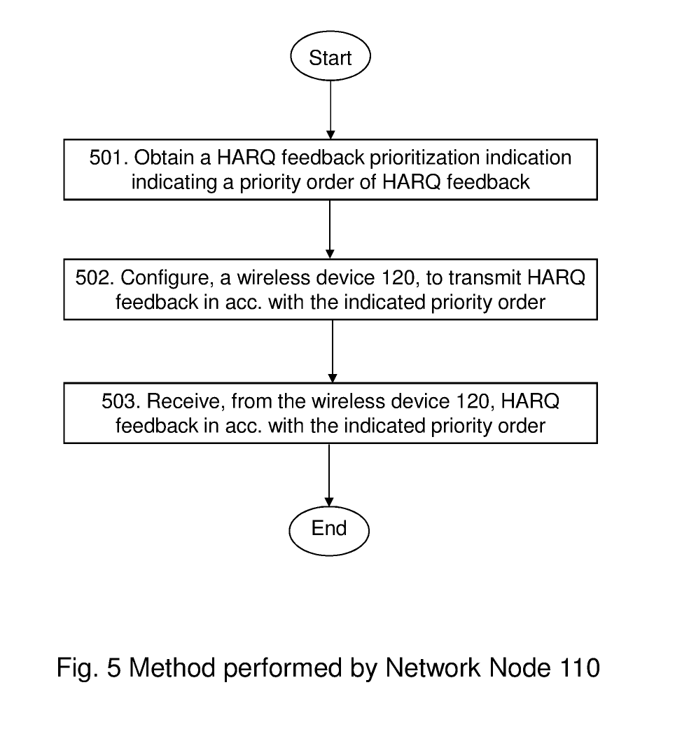

An example of a method performed by the network node 110 for receiving one or more HARQ feedback from the wireless device 120 having the set of HARQ feedback available for transmission will now be described with reference to a flowchart depicted in FIG. 5. As previously described, the wireless device 120 has obtained the set of HARQ feedback for transmission. Further, the wireless device 120 and the network node 110 are operating in the wireless communications system 100.

The method comprises one or more of the following actions. It should be understood that actions may be taken in any suitable order and that some actions may be combined.

Action 501

In some embodiments, the network node 110 obtains the HARQ feedback prioritization indication indicating a priority order of HARQ feedback.

The network node 110 may obtain the HARQ feedback prioritization indication indicating the priority order by receiving the HARQ feedback prioritization indication from another network node, such as the network node 130, e.g. a radio network node, or the core network node 104, comprised in the wireless communications system 100.

In some embodiments, the network node 110 obtains the HARQ feedback prioritization indication indicating the priority order by determining the priority order of HARQ feedback based on a pre-defined set of HARQ feedback priorities. As previously mentioned, the pre-defined set of HARQ feedback priorities may for example be given by a standard specification, e.g. by a 3GPPP MAC protocol standard.

Alternatively and in some embodiments, the network node 110 obtains the HARQ feedback prioritization indication indicating the priority order by determining the priority order of HARQ feedback based on a delay requirement on data transmitted between the wireless device 120 and the network node 110 such that data having a shorter delay requirement is given a higher priority than data having a longer delay requirement.

The delay requirement may be determined based on a quality of service configuration associated with the data transmitted between the wireless device 120 and the network node 110 such that the delay requirement for data associated with a high quality of service is determined to be shorter than the delay requirement for data associated with a low quality of service.

This Action relates to Action 201 described above.

Action 502

In some embodiments, the network node 110 configures the wireless device 120 to transmit one or more HARQ feedback in accordance with the indicated priority order.

In some embodiments, the network node 110 configures the wireless device 120 by sending a RRC configuration message comprising the HARQ feedback prioritization indication or a part thereof.

For example, the network node 110 may then configure the wireless device 120 with a HARQ feedback prioritization table, wherein the table indicates one or more HARQ feedback priorities and what values should match e.g., redundancy version, DCI format, HARQ process, modulation, etc. For example, the table may have an entry specifying that a HARQ feedback for a transmission granted using DCI Format X and that the transmission is using HARQ process 3, 16QAM modulation, redundancy version 2 has priority P. In another example, the table may have an entry specifying that a HARQ feedback for a transmission granted DCI Format X and that the transmissions is using HARQ process 3 has priority P, regardless of the used modulation, redundancy version etc. In such cases, when the wireless device 120 receives a grant, i.e., DCI, it searches through the HARQ feedback prioritization table and finds a table entry that matches the information in the received grant. The found table entry then determines the HARQ feedback priority to be used by the wireless device 120 when transmitting the one or more HARQ feedback to the network node 110.

It should be understood that the term “table” is used only as an example, and that the priority order may be comprised in any kind of list or database suitable for storing priorities.

The network node 110 may configure the wireless device 120 to transmit the one or more HARQ feedback in accordance with the indicated priority order by configuring the wireless device 120 with a set of rules for transmitting the one or more HARQ feedback in accordance with the indicated priority order. For example, the set of rules may comprise a first rule Rule1 stating that a second rule Rule2 is to have priority over a third Rule3, wherein the second rule Rule2 states that a lower HARQ process number has a higher priority than a higher HARQ process number. Further, the third rule Rule2 may state that a higher redundancy version has a higher priority than a lower redundancy version. For example, a HARQ feedback associated with a transmission with (HARQ process, Redundancy version)=(2,3) has a higher priority than a transmission with (HARQ process, Redundancy version)=(3,0), but lower priority than a transmission with (HARQ process, Redundancy version)=(2,1).

Alternatively, the network node 110 may configure the wireless device 120 to transmit the one or more HARQ feedback in accordance with the indicated priority order by configuring the wireless device 120 to prioritize a transmission of data over a transmission of a HARQ feedback. For example, the network node 110 may configure the wireless device 120 to transmit C-MTC data over a background service or a best-effort service.

In some embodiments, the network node 110 configures the wireless device 120 to transmit the one or more HARQ feedback in accordance with the indicated priority by configuring the wireless device 120 to prioritize a transmission of a HARQ feedback indicating an unsuccessful reception over a transmission of a HARQ feedback indicating a successful reception.

In this disclosure, the HARQ feedback indicating an unsuccessful reception may be a Negative-ACKnowledge character (NACK) and the HARQ feedback indicating a successful reception may be an ACKnowledge character (ACK).

Thus, in some embodiments, NACKs are prioritized over ACKs, i.e. the status reporting for HARQ processes requiring retransmissions are prioritized higher than those indicating successful reception. In some embodiments, this is combined with the prioritization as per earlier embodiments so that e.g. the NACKs are prioritized higher than the ACKs in some case for some HARQ processes but not for some other HARQ processes. For example, this may be the case when the data transmitted is delay sensitive and that a re-transmission is needed to be performed as soon as possible.

Further, the network node 110 may configure the wireless device 120 to transmit the one or more HARQ feedback in accordance with the indicated priority order by configuring the wireless device 120 via a higher layer signalling such as a Radio Resource Control (RRC) layer signalling or via a lower layer signalling such as a Medium Access Control (MAC) layer signalling and/or a PHYsical layer (PHY) signalling.

Further, in some embodiments, wherein the wireless device 120 is configured with an in HARQ feedback prioritization, the network node 110 is configured to subsequently modify the HARQ feedback prioritization via higher layer signaling and/or via lower layer signaling.

Action 503

The network node 110 receives, from the wireless device 120, one or more HARQ feedback transmitted in accordance with the indicated priority order, wherein the one or more HARQ feedback are comprised in a proper subset of the set of HARQ feedback.

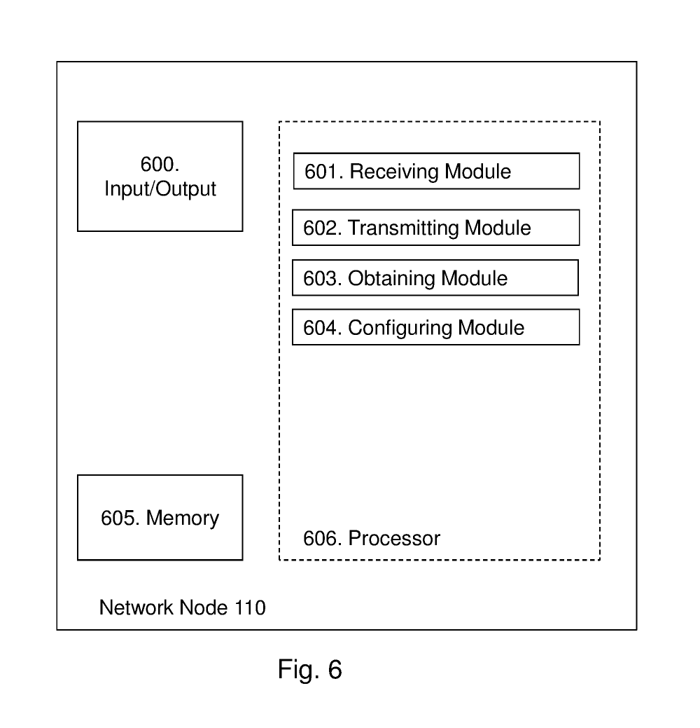

To perform the method for receiving one or more HARQ feedback from the wireless device 120 having the set of HARQ feedback available for transmission, the network node 110 may be configured according to an arrangement depicted in FIG. 6. As previously described, the wireless device 120 has obtained the set of HARQ feedback for transmission. Further, the wireless device 120 and the network node 110 are operating in the wireless communications system 100.

In some embodiments, the network node 110 comprises an input and/or output interface 600 configured to communicate with one or more wireless devices, e.g. the wireless device 120, one or more radio nodes, e.g. the network node 130, and one or more other network nodes, such as the core network node 104. The input and/or output interface 600 may comprise a wireless receiver (not shown) and a wireless transmitter (not shown).

In some embodiments, the network node 110 is configured to receive, e.g. by means of a receiving module 601 configured to receive, from the wireless device 120, one or more HARQ feedback transmitted in accordance with the indicated priority order, wherein the one or more HARQ feedback are comprised in a proper subset of the set of HARQ feedback. The receiving module 601 may comprise a wireless receiver.

The network node 110 is configured to transmit, e.g. by means of a transmitting module 602 configured to transmit, a transmission to the wireless device 120. The transmitting module 602 may comprise a wireless transmitter.

For example, the network node 110 may be configured to transmit, to the wireless device 120, the HARQ feedback prioritization indication indicating a priority order of HARQ feedback.

Further, the network node 110 may be configured to transmit, to the wireless device 120, the UL grant requesting HARQ feedback, e.g. requesting HARQ feedback for a given service.

The network node 110 is configured to obtain, by means of an obtaining module 603 configured to obtain, the HARQ feedback prioritization indication indicating a priority order of HARQ feedback. The obtaining module 603 may be implemented by or arranged in communication with a processor 606 of the network node 110. The processor 606 will be described in more detail below.

In some embodiments, the network node 110 is configured to obtain the HARQ feedback prioritization indication indicating the priority order by further being configured to receive the HARQ feedback prioritization indication from another network node, such as the network node 130, e.g. a radio network node, or a core network node 104, comprised in the wireless communications system 100.

The network node 110 may be configured to obtain the HARQ feedback prioritization indication indicating the priority order by further being configured to determine the priority order of HARQ feedback based on a pre-defined set of HARQ feedback priorities. As previously mentioned, the pre-defined set of HARQ feedback priorities may for example be given by the standard specification, e.g. by the 3GPPP E-UTRA MAC protocol standard.

Further, the network node 110 may be configured to obtain the HARQ feedback prioritization indication indicating the priority order by further being configured to determine the priority order of HARQ feedback based on a delay requirement on data transmitted between the wireless device 120 and the network node 110 such that data having a shorter delay requirement is given a higher priority than data having a longer delay requirement.

In some embodiments, the network node 110 further is configured to determine the delay requirement based on a quality of service configuration associated with the data transmitted between the wireless device 120 and the network node 110 such that the delay requirement for data associated with a high quality of service is determined to be shorter than the delay requirement for data associated with a low quality of service.

Further, the network node 110 may be configured to configure the wireless device 120 to transmit the one or more HARQ feedback in accordance with the indicated priority order by further being configured to configure the wireless device 120 with a set of rules for transmitting the one or more HARQ feedback in accordance with the indicated priority order.

In some embodiments, the network node 110 is configured to configure the wireless device 120 to transmit the one or more HARQ feedback in accordance with the indicated priority order by further being configured to configure the wireless device 120 to prioritize a transmission of data over a transmission of a HARQ feedback.

Further, the network node 110 may be configured to configure the wireless device 120 to transmit the one or more HARQ feedback in accordance with the indicated priority order by further being configured to configure the wireless device 120 to prioritize a transmission of a HARQ feedback indicating an unsuccessful reception over a transmission of a HARQ feedback indicating a successful reception.

As previously mentioned, the HARQ feedback indicating an unsuccessful reception may be a Negative-ACKnowledge character (NACK) and the HARQ feedback indicating a successful reception may be an ACKnowledge character (ACK).

Thus, in some embodiments, NACKs are prioritized over ACKs, i.e. the status reporting for HARQ processes requiring retransmissions are prioritized higher than those indicating successful reception. In some embodiments, this is combined with the prioritization as per earlier embodiments so that e.g. the NACKs are prioritized higher than the ACKs in some case for some HARQ processes but not for some other HARQ processes. As mentioned above, this may be the case when the data transmitted is delay sensitive and that a re-transmission is needed to be performed as soon as possible.

In some embodiments, the network node 110 is configured to configure the wireless device 120 to transmit the one or more HARQ feedback in accordance with the indicated priority order by further being configured to configure the wireless device 120 via a higher layer signalling such as a RRC layer signalling or via a lower layer signalling such as a MAC layer signalling and/or a PHY layer signalling.

Further, in some embodiments, wherein the wireless device 120 is configured with an in HARQ feedback prioritization, the network node 110 is configured to subsequently modify the HARQ feedback prioritization via higher layer signaling and/or via lower layer signaling.

The network node 110 is configured to configure, by means of a configuring module 604 configured to configure, the wireless device 120 to transmit one or more HARQ feedback in accordance with the indicated priority order. The configuring module 604 may be implemented by or arranged in communication with a processor 606 of the network node 110. The processor 606 will be described in more detail below.

The network node 110 may also comprise means for storing data. In some embodiments, the network node 110 comprises a memory 605 configured to store the data. The data may be processed or non-processed data and/or information relating thereto. The memory 605 may comprise one or more memory units. Further, the memory 605 may be a computer data storage or a semiconductor memory such as a computer memory, a read-only memory, a volatile memory or a non-volatile memory. The memory is arranged to be used to store obtained information, data, configurations, schedulings, and applications etc. to perform the methods herein when being executed in the network node 110.

Embodiments herein for receiving one or more HARQ feedback from the wireless device 120 having the set of HARQ feedback available for transmission may be implemented through one or more processors, such as the processor 606 in the arrangement depicted in FIG. 6, together with computer program code for performing the functions and/or method actions of embodiments herein. The program code mentioned above may also be provided as a computer program product, for instance in the form of a data carrier carrying computer program code for performing the embodiments herein when being loaded into the network node 110. One such carrier may be in the form of an electronic signal, an optical signal, a radio signal or a computer readable storage medium. The computer readable storage medium may be a CD ROM disc or a memory stick.

The computer program code may furthermore be provided as program code stored on a server and downloaded to the network node 110.

Those skilled in the art will also appreciate that receiving module 601, the transmitting module 602, the obtaining module 603, and the configuring mode 604 above may refer to a combination of analog and digital circuits, and/or one or more processors configured with software and/or firmware, e.g. stored in the memory 605, that when executed by the one or more processors such as the processors in the network node 110 perform as described above. One or more of these processors, as well as the other digital hardware, may be included in a single Application-Specific Integrated Circuitry (ASIC), or several processors and various digital hardware may be distributed among several separate components, whether individually packaged or assembled into a System-on-a-Chip (SoC).

When the word “comprise” or “comprising” is used in this disclosure it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention, which is defined by the appending claims.

Abbreviations

3GPP Third Generation Partnership Program

ARQ Automatic Repeat re-Quest

C-MTC Critical MTC

DL Downlink

eNodeB/eNB Evolved Node B

HARQ Hybrid ARQ

MAC Medium Access Control

MSN Message Sequence Number

MTC Machine Type Communications

NDI New Data Indicator

NW Network

PDSCH Physical Downlink Shared Channel

PHY Physical (Layer)

PUCCH Physical Uplink Common Control Channel

PUSCH Physical Uplink Shared Channel

QCI QoS Identifier

QoS Quality of Service

RRC Radio Resource Control

RV Redundancy Version

Rx Receive

TDD Time-Division Duplex

TTI Transmission-Time Interval

Tx Transmit

UE User Equipment

UL Uplink

1. A method performed by a wireless device for transmitting one or more Hybrid Automatic Repeat reQuest, HARQ, feedbacks to a network node, wherein the wireless device has a set of HARQ feedback available for transmission, wherein the wireless device and the network node are operating in a wireless communications system, and wherein the method comprises:
obtaining a HARQ feedback prioritization indication indicating a priority order of HARQ feedback; and
transmitting, to the network node, one or more HARQ feedback in accordance with the indicated priority order, wherein the one or more HARQ feedback are comprised in a proper subset of the set of HARQ feedback.

2. The method of claim 1, wherein the obtaining of the HARQ feedback prioritization indication indicating the priority order comprises:
receiving the HARQ feedback prioritization indication from the network node.

3. The method of claim 1, wherein the obtaining of the HARQ feedback prioritization indication indicating the priority order comprises:
determining the priority order of HARQ feedback based on a pre-defined set of HARQ feedback priorities.

4. The method of claim 1, wherein the obtaining of the HARQ feedback prioritization indication indicating the priority order comprises:
determining the priority order based on one or more of: a HARQ process associated with the HARQ feedback, a Downlink Control Information, DCI, and/or a redundancy version.

5. The method of claim 1, further comprising:
altering an uplink grant requesting HARQ feedback to alter an amount of resources used for transmitting the one or more HARQ feedback.

6. A wireless device for transmitting one or more Hybrid Automatic Repeat reQuest, HARQ, feedbacks to a network node, wherein the wireless device has a set of HARQ feedback available for transmission, wherein the wireless device and the network node are operating in a wireless communications system, and wherein the wireless device is configured to:
obtain a HARQ feedback prioritization indication indicating a priority order of HARQ feedback; and
transmitting, to the network node, one or more HARQ feedback in accordance with the indicated priority order, wherein the one or more HARQ feedback are comprised in a proper subset of the set of HARQ feedback.

7.-9. (canceled)

10. The wireless device of claim 6, wherein the wireless device further is configured to:
alter an uplink grant requesting HARQ feedback to alter an amount of resources used for transmitting the one or more HARQ feedback.

11. A method performed by a network node for receiving one or more Hybrid Automatic Repeat reQuest, HARQ, feedbacks from a wireless device having a set of HARQ feedback available for transmission, wherein the network node and the wireless device are operating in a wireless communications system, and wherein the method comprises:
obtaining a HARQ feedback prioritization indication indicating a priority order of HARQ feedbacks;
configuring the wireless device to transmit one or more HARQ feedback in accordance with the indicated priority order; and
receiving, from the wireless device, one or more HARQ feedback transmitted in accordance with the indicated priority order, wherein the one or more HARQ feedback are comprised in a proper subset of the set of HARQ feedback.

12. The method of claim 11, wherein the obtaining of the HARQ feedback prioritization indication indicating the priority order comprises:
receiving the HARQ feedback prioritization indication from another network node, such as a radio network node or a core network node, comprised in the wireless communications system.

13. The method of claim 11, wherein the obtaining of the HARQ feedback prioritization indication indicating the priority order comprises:
determining the priority order of HARQ feedback based on a pre-defined set of HARQ feedback priorities.

14. The method of claim 11, wherein the obtaining of the HARQ feedback prioritization indication indicating the priority order comprises:
determining the priority order of HARQ feedback based on a delay requirement on data transmitted between the wireless device and the network node such that data having a shorter delay requirement is given a higher priority than data having a longer delay requirement.

15. The method of claim 14, wherein the delay requirement is determined based on a quality of service configuration associated with the data transmitted between the wireless device and the network node such that the delay requirement for data associated with a high quality of service is determined to be shorter than the delay requirement for data associated with a low quality of service.

16. The method of claim 11, wherein the configuring of the wireless device to transmit one or more HARQ feedback in accordance with the indicated priority order further comprises:
configuring the wireless device with a set of rules for transmitting the one or more HARQ feedback in accordance with the indicated priority order.

17. The method of claim 11, wherein the configuring of the wireless device to transmit one or more HARQ feedback in accordance with the indicated priority order comprises:
configuring the wireless device to prioritize a transmission of data over a transmission of a HARQ feedback.

18. The method of claim 11, wherein the configuring of the wireless device to transmit one or more HARQ feedback in accordance with the indicated priority order comprises:
configuring the wireless device to prioritize a transmission of a HARQ feedback indicating an unsuccessful reception over a transmission of a HARQ feedback indicating a successful reception.

19. The method of claim 11, the configuring of the wireless device to transmit one or more HARQ feedback in accordance with the indicated priority order comprises:
configuring the wireless device via a higher layer signalling such as a Radio Resource Control, RRC, layer signalling or via a lower layer signalling such as a Medium Access Control, MAC, layer signalling and/or a PHYsical layer, PHY, signalling.

20. A network node for receiving one or more Hybrid Automatic Repeat reQuest, HARQ, feedbacks from a wireless device having a set of HARQ feedback available for transmission, wherein the network node and the wireless device are operating in a wireless communications system, and wherein the network node is configured to:
obtain a HARQ feedback prioritization indication indicating a priority order of HARQ feedback;
configure the wireless device to transmit one or more HARQ feedback in accordance with the indicated priority order; and
receive, from the wireless device, one or more HARQ feedback transmitted in accordance with the indicated priority order, wherein the one or more HARQ feedback are comprised in a proper subset of the set of HARQ feedback.

21. The network node of claim 20, wherein the network node is configured to obtain the HARQ feedback prioritization indication indicating the priority order by being configured to:
receive the HARQ feedback prioritization indication from another network node, such as a radio network node or a core network node, comprised in the wireless communications system.

22.-25. (canceled)

26. The network node of claim 20, wherein the network node is configured to configure the wireless device to transmit one or more HARQ feedback in accordance with the indicated priority order by being configured to:
configure the wireless device to prioritize a transmission of data over a transmission of a HARQ feedback.

27. The network node of claim 20, wherein the network node is configured to configure the wireless device to transmit one or more HARQ feedback in accordance with the indicated priority order by being configured to:
configure the wireless device to prioritize a transmission of a HARQ feedback indicating an unsuccessful reception over a transmission of a HARQ feedback indicating a successful reception.

28.-30. (canceled)
